(19) United States
(12) Patent Application Publication
(10) Pub. No.: US 2014/0136221 A1
(43) Pub. Date: May 15, 2014

(54) ONLINE MATCHING SYSTEM BETWEEN PATIENT AND CURER

(71) Applicant: In Seong NA, Yangju-si (KR)

(72) Inventor: In Seong NA, Yangju-si (KR)

(21) Appl. No.: 14/020,977

(22) Filed: Sep. 9, 2013

(30) Foreign Application Priority Data
Nov. 14, 2012 (KR) 10-2012-0128691

(51) Int. Cl. G06Q 50/22; G06Q 30/06

(52) U.S. Cl. CPC G06Q 50/22; G06Q 30/0627
USPC 705/2

(57) ABSTRACT

Disclosed is an online matching system between a patient and curer which provides an effective medical service by matching the patient and curer using an online social network with the advent of a personalized medical treatment age. The online matching system between a patient and curer includes a patient terminal and a curer terminal which are configured for a user to join as a member to a matching service server connected through a data communication network, and log in to perform registration and inquiry, and the matching service server which manages by matching a first group data in which the patient's disease-related information registered is grouped by type of disease and a second group data in which the curer's research-and-treatment-related information registered is grouped by area of research. The matching service server connects the patient and curer terminals through the data communication network.

### RELATED APPLICATIONS

This application claims priority to Korean Patent Application No. 10-2012-0128691, filed on Nov. 14, 2012 in the Korean Intellectual Property Office, the entire disclosure of which is incorporated herein by reference.

### BACKGROUND OF THE INVENTION

1. Field of the Invention

The present invention. relates to an online matching system between a patient and curer, especially in one embodiment, to an online matching system between a patient and curer which provides an effective medical service by matching the patient and curer using an online social network with the advent of a personalized medical treatment age.

2. Description of the Related Art

In modern societies, only limited medical treatment is available for many reasons including a lack of research due to insufficient treatment expenses and insufficient research funds for diseases. Due to such a medical environment, many patients are suffering from various problems. Moreover, in producing medicine and medical supplies for administering to patients, the current medicine and medical supplies production system is based on mass production. Accordingly, because it should be regulated by consultative agencies such as the FDA, a lot of manpower and time is required.

On the other hand, the development of modern biomedical sciences foresees advent of a personalized medical treatment age. As an example, cell therapy and gene therapy may be indicated. Further, the development of genome science helps effective personalized medical treatment become possible by analyzing the genome information of a patient. Along with this, the development of modern information technology provides a variety of social networks for individuals or groups to play a large role in sharing information easily with each other. Therefore, it is necessary to research a more cooperative and efficient personalized medical treatment system to solve problems of inconvenience that patients have suffered and provide convenience to curers.

### SUMMARY OF THE INVENTION

Accordingly, it is an object of the present invention to provide an online matching system between a patient and curer, whereby a patient group is formed for each disease and a curer group for the relevant disease by using an online social network, and each patient group is matched with each curer group for positive and efficient treatment of the disease.

Another object of the present invention is to provide an online matching system between a patient and curer, whereby participation by the government, companies, research institutes, etc., is encouraged so that the benefits of treatment are provided to patients for whom disease treatment funds are insufficient and the opportunities for research are provided to curers for whom the research funds for disease treatment are insufficient.

Further, another object of the present invention is to provide an online matching system between a patient and curer, configured to overcome the current dependence of medical services on medical doctors, technical constraints, geographical constraints, and constraints of time due to regulatory agencies' examination process for medicines and the medical supplies mass-production system.

In order to accomplish the foregoing objects, according to an embodiment of the present invention, there is provided an online matching system between a patient and curer including: a patient terminal configured for a user to join as a member to a matching service server connected through a data communication network or a web server, and log in to perform registration and inquiry of a patient's disease-related information; a curer terminal configured for a user no join as a member to the matching service server connected through the data communication network or the web server, and log in to perform registration and inquiry of a curer's research-and-treatment-related information; and the matching service server, which manages by matching a first group data in which the patient's disease-related information registered by patients is grouped by type of disease and a second group data in which the curer's research-and-treatment-related information registered by curers is grouped by area of research, and in which when the patient's disease-related information is provided from the patient terminal, the relevant patient's disease-related information of the first group data is transmitted to the curer's terminal and the curer's research-and-treatment-related information of the second group data is transmitted to the patient terminal, wherein the matching service server may connect the patient terminal and the curer terminal to each other through the data communication network or a website.

The matching service server may include a registered member management unit configured to manage after receiving a patient's personal information and a curer's personal information input through the patient terminal and the curer terminal and registering them as members after taking the authentication procedure; a data communication unit configured to receive the patient's disease-related information and the curers research-and-treatment-related information from the patient terminal and the curer terminal connected through the data communication network and the web server and group each information, then transmit the other's grouped information to the patient terminal and the curer terminal; a first group data generation unit configured to generate a first group data in which the patient's disease-related information is grouped by type of disease; a second group generation unit configured to generate a second group data in which the curer's research-and-treatment-related information is grouped by area of research; a data matching unit configured to match the first group data and the second group data with each other based on a predetermined matching standard; a matching recommendation unit configured to recommend optimum data group based on a predetermined important information of the first group data and the second group data; a terminal connecting unit configured to connect the patient terminal and the curer terminal selected by the patient from the patient terminal through the data communication network or the website; a data storage unit configured to store the patient's personal information and the disease-related information, the curer's personal information and the curer's research-and-treatment-related information, and the first group data and the second group data; an external information source providing unit configured to receive the patient's disease-related information and the curer's research-and-treatment-related information in conjunction with an external information providing server; and a controller configured to control the operation of each unit and control update of data when additional data is input from the patient terminal, the curer terminal, the data matching recommendation unit, and the external information source providing unit.

The first group data generation unit may further include a third group data generation unit configured to group the first group data into a patent's physical information category and a residential area information category based on a patient's physical information and residential area information additionally registered.

The terminal connecting unit may further include a treatment room generation unit configured to, when the patient terminal and the curer terminal selected by the patient from patient terminal is connected through the data communication network or the web server, generate a predetermined treatment room and provide the generated treatment room so the patient terminal and the curer terminal.

The patient's disease-related information may include at least any one of disease history information and genome information.

The curer's research-and-treatment-related information may include at least any one of research field information, research history information, publications list information and education history information.

In addition, in the online matching system between a patient and curer according to one embodiment of the present invention, the operator of the system can directly intervene in all operations for control.

It is possible to increase the treatment efficiency by promoting dynamic communication between a patient and curer for a specific disease.

Further, it is possible to raise funds necessary for disease treatment and research by inducing participation by various social organizations.

It is also possible to overcome various constraints of the conventional medical services.

### BRIEF DESCRIPTION OF THE DRAWINGS

The above and other objects, features and other advantages of the present invention will be more clearly understood from the following detailed description taken in conjunction with the accompanying drawings, in which:

FIG. 1. is a block diagram illustrating an online matching system between a patient and curer according to one embodiment of the present invention;

FIG. 2 is a flowchart schematically illustrating the operating sequence of FIG. 1; and

FIGS. 3A and 3B are drawings illustrating the matching operation by a matching service server and an example illustrating first group data and second group data.

### DETAILED DESCRIPTION OF THE INVENTION

Hereinafter, preferred embodiments of the present invention will be described in detail with reference to the accompanying drawings so as to embody the present invention for those skilled in the related art.

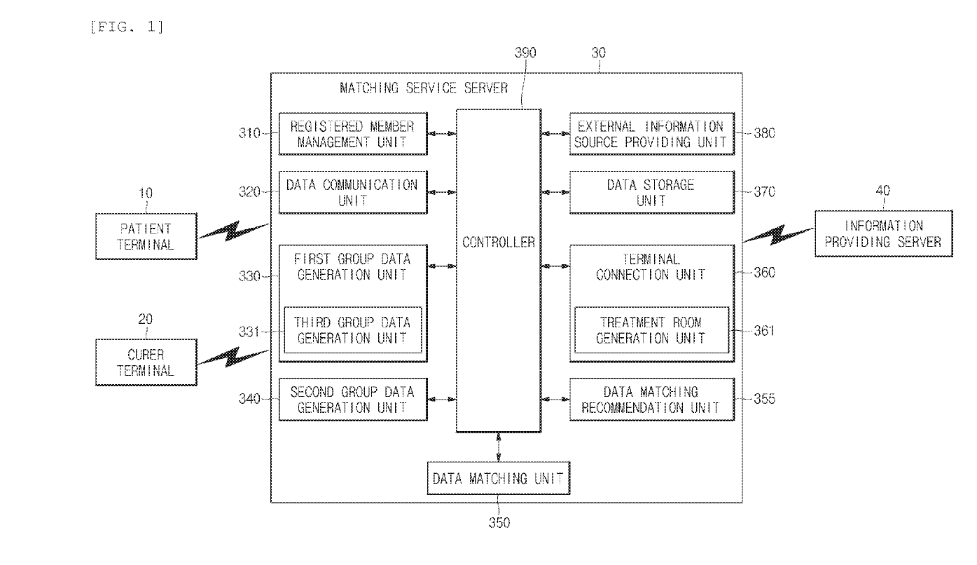

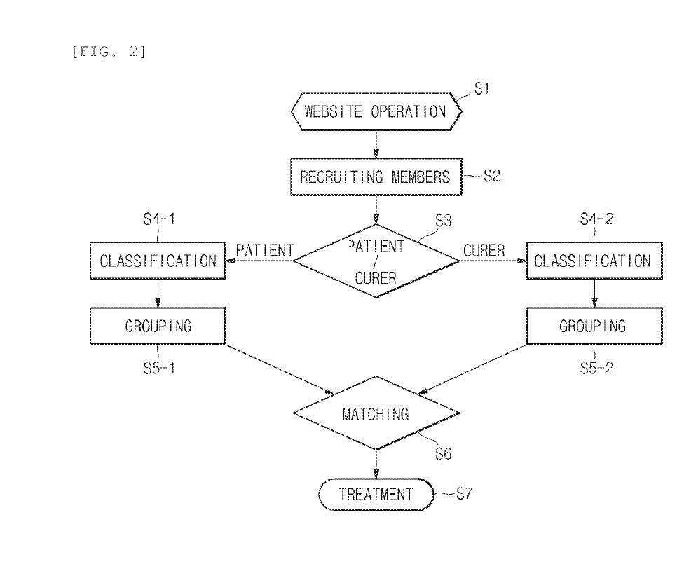

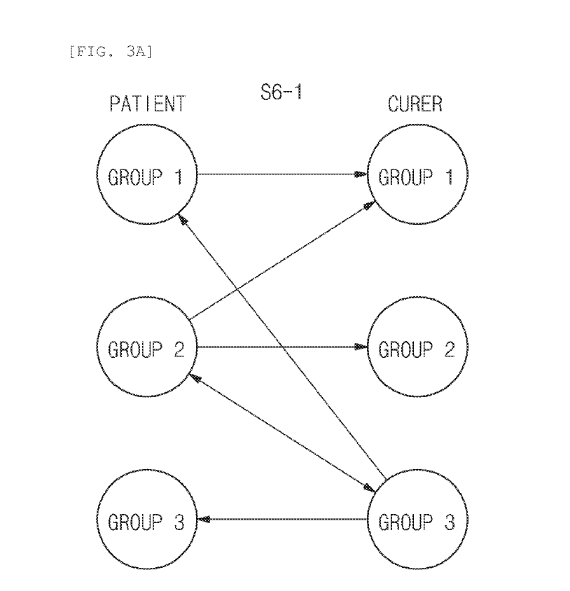

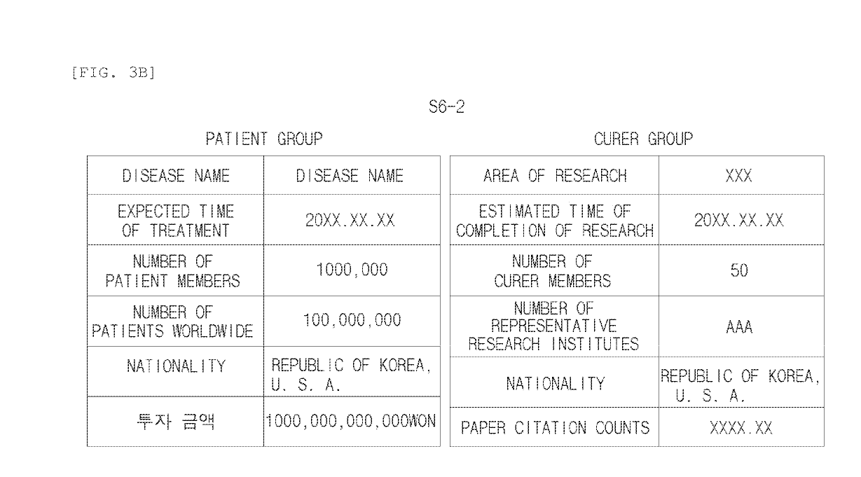

FIG. 1 is a block diagram illustrating an online matching system between a patient and curer according to one embodiment of the present invention, and FIG. 2 is a flowchart schematically illustrating the operating sequence of FIG. 1, and FIGS. 3A and 3B are drawings illustrating the matching operation by a matching service server and an example illustrating first group data and second group data.

With reference to FIG. 1, an online matching system between a patient and curer according to one embodiment of the present invention includes a patient terminal 10, a curer terminal 20 and a matching service server 30.

The patient joins as a member through the patient terminal 10 to the matching service server 30 connected through a data communication network or a web server, and can log in to perform registration and inquiry of information related to patient's disease. That is, each patient connects to the matching service server 30 through the patient terminal 10 to input his or her personal information and disease-related information and receives information input, from the curer terminal 20. In order to carry out such a function, the patient terminal 10 has an input/output function for communicating with the matching service server 30 through a communication network (that is, a data communication network or a web server). This patient terminal 10 may include, without particular limitation, any operating means such as a desktop computer, a notebook computer, a workstation, a palmtop computer, and a personal digital assistant (PDA) and a web pad as well, as mobile communication terminals including a smart phone. That is, any digital equipment having computing ability with a microprocessor disposed therein can be used as the patient terminal 10 according to the present invention.

The curer joins as a member through the curer terminal 20 to the matching service server 30 connected through the data communication network or the web server, and can log in to perform registration and inquiry of information related to the curer's research and treatment. That is, the curer connects to the matching service server 30 through the curer terminal 20 to input his or her personal information and information related to curer's research and treatment, and receives information on the patient input from the patient terminal 10. In order to carry out such a function, the curer terminal 20 has an input/output function for communicating with the matching service server 30 through the communication network (that is, the data communication network or the web server). This curer terminal 20 may be a hospital server, or mobile communication terminals including a smart phone that can treat the patient. However, the present invention is not limited the curer terminal 20 and the curer terminal may include any operating means such as a desktop computer, a notebook computer, a workstation, a palmtop computer, and a personal digital assistant (PDA) and a web pad. That is, any digital equipment having computing ability with a microprocessor disposed therein can be used as the curer terminal 20 according to the present invention.

The matching service server 30 is connected to each of the patient terminal 10 and the curer terminal 20 through the communication network, is built separately by a service operator, and is designed to operate in interlock with the patient terminal. 10, the curer terminal 20, and an external information providing server 40. Here, the communication network may be configured in communication methods of various wire and wireless forms such as PAN (personal area network), LAN (local area network), MAN (metropolitan area network) and WAN (wide area network). Further, the communication network may be the well-known WWW (world wide web), or may use wireless transmission technology used in short-range communication such as IrDA (Infrared Data Association) or Bluetooth. Below in the description of the present invention, the communication network will be referred to as the data communication network or the web server.

Further, the matching service server 30 manages first group data, in which a patient's disease-related information registered by the patient from the patient terminal 10 is grouped by type of disease, and second group data, in which a curer's research-and-treatment-related information registered by the curer from the curer terminal 20 is grouped by area of research, by matching them in a data matching unit 350 to be described below. Preferably, data before matching are managed in a data storage unit 370 to be described below. Further, when the matching service server 30 receives the patient's disease-related information from the patient terminal 10, the matching service server 30 can transmit to the curer terminal 20 the patient's disease-related information of the first group data, and can transmit to the patient terminal 10 the curer's research-and-treatment-related information of the second group data.

Such a matching service server 30 carries out the role of connecting the patient terminal 10 and the curer terminal 20 selected by the patient from the patient terminal 10 to each other through the data communication network or the website.

In order to realize such an operation, the matching service server 30 includes a registered member management unit 310, a data communication unit 320, a first group data generation unit 330, a second group data generation unit 340, the data matching unit 350, a data matching recommendation unit 355, a terminal connecting unit 360, a data storage unit 370, an external information source providing unit 380 and a controller 390.

The registered member management unit 310 carries out the role of receiving a patient's personal information and a curer's personal information input from the patient terminal 10 and the curer terminal 20 and authenticating them as members, and then managing them as registered members. That is, the registered member management unit 310, on receiving a request for membership from the patient terminal 10 or the curer terminal 20, stores the patient's or curer's information input during a registering process in the data storage unit 370 to register him or her as a member. After that, the registered member management unit 310, at the request or log-in by the patient or curer registered as a member, checks the registered member information stored in the data storage unit 370 to carry out the log-in process.

The data communication unit 320 connected to the patient terminal 10 and the curer terminal 20 through the data communication network or the web server receives the patient's disease-related information and the curer' s research-and-treatment-related information from each terminal, groups the various types of information, and then transmits the grouped information to the patient terminal 10 and the curer terminal 20.

The first group data generation unit 330 groups the patient's disease-related information by type of disease to generate first group data. That is, the first group data generation unit 330 can group the disease-related information of a plurality of patients by type of disease, or group a plurality of disease-related information of one patient by type of disease. Patient's disease-related information may include at least any one of disease history information and genome information . At this time, the grouped patient's disease-related information may be set additionally, and the grouped information may be mapped to the relevant first group data by the first group data generation unit 330 to generate data. Further, for efficient grouping, the operating team of the present system may intervene in grouping the first group data.

Moreover, the first group data generation unit 330 may further include a third group data generation unit 331, in which a patient's physical information and residential area information are registered additionally to have them grouped into the patient's physical information and residential area information categories.

The second group data generation unit 340 generates second group data in which curer's research-and-treatment related information is grouped by area of research. That is, the second group data generation unit 340 can group the information related to research and treatment of a plurality of curers by area of research, or group the information related to a plurality of research and treatment of one curer by area of research. The curer's research-and-treatment-related information may include at least any one of research field information, research history information, publications list information and education history information. At this time, the second group data generation unit 340 may further set the grouped research-and-treatment-related information, and map the grouped information no the relevant second group data to generate data. Further, for efficient grouping, the operation team of the system may intervene in grouping the second group data.

The data matching unit 350 matches the first group data and the second group data based or a predetermined matching standard. That is, the data matching unit 350 matches by mapping the first group data, in which patient's disease-related information is grouped by area of disease, and the second group data, in which curer's research-and-treatment-related information is grouped by area of research. Further, the data matching unit 350 can match the first group data, which are grouped including the patient's disease-related information set additionally, with the second group data.

The data matching recommendation unit 355 recommends optimum data based on important information of the first group data and the second group data, when matching the data of the data matching unit 350. That is, the data matching recommendation unit 355 can recommend important information of the first group data and the second group data defined beforehand by the operating team of the matching service server 30 to the patient terminal 10 or the curer terminal 20 so as to be referred to during information registering, or recommend it to the data matching unit 350 so as to be referred to first during data matching.

The terminal connecting unit 360 carries out the role of connecting the patient terminal 10 and the curer terminal 20 selected by the patient from the patient terminal 10 to each other through the data communication network or a website. That is, the terminal connecting unit 360 can connect the patient terminal 10 and the curer terminal 20 selected by the patient from the patient terminal 10 to each other through the data communication network, or can have them connect to a website to connect to each other. Thereby, the patient can get advice and treatment remotely, and receive help for treatment and management before and after medical treatment from the curer. Optionally, the terminal connecting unit 360 may further include a treatment room generation unit 361 for providing a predetermined dialogue space (that is, the treatment room). That is, when the patient terminal 10 and the curer terminal 20 selected by the patient from the patient terminal 10 are connected through the data communication network or the website, the treatment room generation unit 361 generates the treatment room. Therefore, the patient can get remote counseling and treatment from the curer through the treatment room.

The data storage unit 370 stores the patient's personal information and disease-related information, the curer's personal information and research-and-treatment-related information, and the first group data and the second group data.

The external information source providing unit 380 is provided with the patient's disease-related information and the curer's research-and-treatment-related information in conjunction with the external information providing server 40. Further, the external information source providing unit 380 transmits to the data storage unit 370 the patient's disease-related information and the curer's research-and-treatment-related information received from the external information providing server 40, so that the external information source providing unit 380 can supply them to components such as the registered member management unit 310 and the data matching unit 350.

The controller 390 controls the operations of the each unit described above and can control data update when additional data are input from the patient terminal 10, the curer terminal 20, the data matching recommendation unit 355 and the external information source providing unit 380. Further, the controller 390 can be adjusted as necessary to enhance the effect of data matching by the operating team of the present system.

Therefore, according to the online matching system between a patient and curer according to one embodiment of the present invention, it is possible to carry out effective treatment by matching the patient group and the curer group based on an online social network.

With reference to FIGS. 2 to 3B, the operation of the online matching system between a patient and curer according to one embodiment of the present invention having the above described configuration will be described specifically.

First, with reference to FIG. 2, the online matching system between a patient and curer according to the present invention operates a website online to access a user (step S1). Members are recruited on the website being operated at step S1 to join as a member (S2). Next, the members recruited at step S2 are classified into patients, curers and general members (step S3). The members classified into patients at step S3 are classified into patient members by type of disease (step S4-1). On the other hand, the members classified into curers at step S3 are classified into curer members by area of research (step S4-2). Next, the patient members classified at step S4-1 are grouped (step S5-1), and the curer members classified at step S4-2 are grouped (step 5-2). After this, the patient members grouped at S5-1 and the curer members grouped at step 5-2 are matched (step S6), and the curer members carry out treatment for the patient members matched at step S6 (step 7).

In more detail, at step S1, the matching system between a patient and curer operates an online website for providing the relevant service. This step includes all processes necessary for building and using the website online. The online website includes as much information on diseases as possible. On the other hand, funds or profits necessary for carrying out treatment of diseases can be made at step S1. For example, a banner of a company can be linked to induce the company to make investments, or direct investment can be promoted by dispensing with the member joining procedure to induce investments from individuals or organizations.

At step S2, a user including patients and curers may join as a member on the online website operating the matching system between a patient and curer. At this step, the user provides his or her personal information to the online website for the membership and registers as a member after taking a predetermined procedure. User information is input through an internet connection from any equipment possible of information input. Further, information input at step S2 may basically include the member's residential address, e-mail address, workplace address, cell, phone number, home telephone number, age and sex, etc. To join as a patient member in step S3, the user may additionally input disease-related information, disease history information, genome information, etc. Further, to join as a curer member in step S3, the user may additionally input his or her area of research information, history of research activities information, theses list information, education history information, etc.

Meanwhile, step S2 may be configured in such a way that the user can refer to external, information sources when inputting information for a patient or curer membership. For example, a user who intends be a patient member may refer to an external information source received from the external information providing server where the user can view treatment records, and a user who intends to be a curer member may refer to a specific publication that he is interested in on the relevant website by interlocking with an external information providing server such as a website specializing in academic papers.

Further, payments may be made at step S2 for raising funds necessary for carrying out treatment of diseases. For example, necessary funds can be raised by making use of a membership system, in which no-charge services are provided for a month after becoming a member but a predetermined amount of money should be paid periodically henceforth.

Further, any user who is not registered as a member at step S2, chat is, a non-member, may be allowed to use the website on a limited level. For example, connection may be allowed to a non-member, if a user accesses the website for a purpose of investment or obtaining information after a final treatment. Furthermore, at step S2, personnel of the relevant organization may get membership through a contract with an organization such as a company or a government agency.

The users who have joined as members are classified into patient members and curer members at step S3. Further, at step S3, it is possible to classify into patient members, curer members or general members by considering what the users want, and make a plurality of choices possible so that one user who has joined as a member can have a plurality of qualifications. Further, the members classified at step S3 can view the information of a specific member, but this may be limited by the member's deciding his or her information disclosure level. Therefore, it is possible to confirm members' personal information with each other after step S1 through such a process.

The patient members are classified into many sections based on a specific disease at step S4-1. Further, one patient member could have a plurality of diseases, so one patient member could be classified into the sections of a plurality of diseases. At step S4-1, in case a specific patient should additionally input a disease that was left out at step S1, it is possible no immediately update the information of the disease additionally input. Further, at step S4-1, it is possible to create a virtual space where the opinions of patient members can be reflected, since any disease can have a variety of causes.

The curer members are classified into many sections based on the area of research at step S4-2. Since one curer member can have a plurality of areas of research, one curer member could be classified into the section of a plurality of areas of research.

The patient members are grouped into categories based on a specific disease at step S5-1. Further, it is possible to group the patient members by considering each patient member's physical and residential area characteristics at step S5-1. Meanwhile, at step S5-1, the operating team may participate in the grouping process to help with grouping. Therefore, they can help a specific patient group find a specific curer group at step S6 after grouping.

The curer members are grouped into categories based on a specific field of research at step S5-2. Further, it is possible to group the curer members by considering each curer's research. orientation, etc at step S5-2. For example, the curer members may be grouped into categories by considering such information of curers who actually conduct experiments, curers who make computer analysis, and curers who specialize in genome information. Meanwhile, at step S5-2, the operating team may participate in the grouping process to help with grouping. Therefore, they could help a specific curer group find a specific patient group at step S6 after grouping.

The patient group and the curer group are matched at step S6. Any group may participate freely at step S6, but the operating team can participate for smooth communication. For example, the operating team may introduce a recommended partner group to each group.

With reference to FIG. 3A, at step S6-1, a specific patient group can try to contact a plurality of specific curer groups to obtain information. Conversely, at step S6-1, a specific curer group may try to contact a plurality of specific patient groups. At this time, the operating team may intervene in the contact.

With reference to FIG. 3B, at step S6-2, the operating team can increase the matching efficiency by building important information of each group for optimum matching. That is, at step S6-2, the operating team may provide the patient group with important information such as the disease name, expected time of treatment, number of patient members, number of patients worldwide, nationality and investment amount. In addition, the operating team may provide the curer group with important information such as the area of research, estimated time of completion of research, number of curer members, representative research institutes, nationality and paper citation counts.

At step S7, the curer group carries out treatment for the patient group matched at step S6. That is, at step S7, a treatment room is opened in the website or the patient and the curer are connected through the data communication network so that the curer group can carry out treatment for the patient group matched on the online website. Meanwhile, it can induce investment from many organizations in such a process. For example, after formulating a treatment plan, it may ask for investment from a national agency such as the Korea National Institute of Health. The operating team may participate in such a process. Further, at step S7, many methods may be carried out simultaneously in some cases to find and carry out an effective treatment method. That is, at step S7, it is possible to find out individual characteristics of the patient member group through gene analysis and conduct cell treatment accordingly, and build facilities of research for personalized medical services, production and quality control and the operation systems thereof. Further, at step S7, in order to induce positive participation of the patient group, the patient group or an individual member of the patient group can also personally confirm and select the research, production and quality control processes necessary for treatment through the help of the curer group or a curer member. In addition, in order to indirectly confirm whether the step S7 is successful or not, a virtual clinical test result estimating program may be operated. For example, it is possible to use a computer program. made by including the concepts of statistics, bioinformatics, chemistry, physics, mathematics, biophysics and biochemistry. Further, after step S7, in preparation for the time when the expected effect was not derived from step S7, the relevant patient may be compensated properly in conjunction with insurance. Further, the treatment results and research results derived after carrying out the step S7 and the resulting profits may be distributed after discussion with the operating team, patient member group, curer member group and investors. Furthermore, after step S7, a relevant department may be set up in the operating to check whether the overall process is being carried out correctly through the relevant work, so as to be able to verify from time to time whether the overall process is righteous, whether there are no moral-ethical problems, and whether there are no problems in terms of history.

The embodiment described above is just an example for realizing the online matching system between a patient and curer according to the present invention. However, the present invention is not limited thereto, and it will be understood by those skilled in the related art that various modifications and variations may be made therein without departing from the scope of the present invention as defined by the appended claims.

What is claimed is:

1 An online matching system between a patient and curer comprising:
a patient terminal configured for a user to join as a member to a matching service server connected through a data communication network or a web server, and log in to perform registration and inquiry of a patient's disease-related information;
a curer terminal configured for a user to join as a member to the matching service server connected through the data communication network or the web server, and log in to perform registration and inquiry of a curer's research-and-treatment-related information; and
the matching service server, which manages by matching a first group data in which the patient's disease-related information registered by patients is grouped by type of disease and a second group data in which the curer's research-and-treatment-related information registered by curers is grouped by area of research, and in which when the patient's disease-related information is provided from the patient terminal, the relevant patient's disease-related information of the first group data is transmitted to the curer's terminal and the curer's research-and-treatment-related information of the second group data is transmitted so the patient terminal,
wherein the matching service server connects the patient terminal and the curer terminal to each other through the data communication network or a website.

2. The system of claim 1, wherein the matching service server comprises:
a registered member management unit configured to manage after receiving a patient's personal information and a curer's personal information input through the patient terminal and the curer terminal and registering them as members after taking the authentication procedure;
a data communication unit configured to receive the patient's disease-related information and the curer's research-and-treatment-related information from the patient terminal and the curer terminal connected through the data communication network and the web server and group each information, then transmit the other's grouped information to the patient terminal and the curer terminal;
a first group data generation unit configured to generate a first group data in which the patient's disease-related information is grouped by type of disease;
a second group generation unit configured to generate a second group data in which the curer's research-and-treatment-related information is grouped by area of research;
a data matching unit configured to match the first group data and the second group data with each other based on a predetermined matching standard;
a matching recommendation unit configured to recommend optimum data group based on a predetermined important information of the first group data and the second group data;
a terminal connecting unit configured to connect the patient terminal and the curer terminal selected by the patient from the patient terminal through the data communication network or the website;
a data storage unit configured to store the patient's personal information and the disease-related information, the curer's personal information and the curer's research-and-treatment-related information, and the first group data and the second group data;
an external information source providing unit configured to receive the patient's disease-related information and the curer's research-and-treatment-related information in conjunction with an external information providing server; and
a controller configured to control the operation of each unit and control update of data when additional data is input from the patient terminal, the curer terminal, the data matching recommendation unit, and the external information source providing

3. The system of claim 2, wherein the first group data generation unit further includes a third group data generation unit configured to group the first group data into a patient's physical information category and a residential area information category based on a patient's physical information and residential area information additionally registered.

4. The system of claim 2, wherein the terminal connecting unit further includes a treatment room generation unit configured to, when the patient terminal and the curer terminal selected by the patient from patient terminal is connected through the data communication network or the web server, generate a predetermined treatment room and provide the generated treatment room to the patient terminal and the curer terminal.

5. The system. of claim 1, wherein the patient's disease-related information includes at least any one of disease history information and genome information.

6. The system of claim 1, wherein the curer's research-and-treatment-related information includes at least any one of research field information, research history information, publications list information and education history information.
